(19) United States
(12) Patent Application Publication
(10) Pub. No.: US 2010/0182633 A1
(43) Pub. Date: Jul. 22, 2010

(54) PERIPHERAL DEVICE AND MOTHED FOR CONFIGURING WIRELESS PRINTING ENVIRONMENT

(75) Inventors: YI-FANG WU, Tu-Cheng (TW); YONG-HUI XIAO, Shenzhen City (CN); YE YUAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/548,093

(22) Filed: Aug. 26, 2009

(30) Foreign Application Priority Data
Jan. 16, 2009 (CN) 200910300235.1

(51) Int. Cl. G06F 3/12; G06F 9/445

(52) U.S. Cl. 358/1.15; 717/176

(57) ABSTRACT

A device for configuring wireless printing environment includes a wireless network adapter, a storage device, and a wireless printing environment configuring module. The storage device stores a wireless network adapter driver. The wireless printing environment configuring module installs the wireless network adapter driver in a computer and configures a wireless environment for the computer so as to enable the computer to communicate with wireless electronic devices via a wireless network. The wireless printing environment module finds a printer from a network and provides print service for the computer to print a file.

### BACKGROUND

1. Technical Field

The present disclosure relates to peripheral devices and methods, and particularly, to a peripheral device and a method for configuring a wireless printing environment.

2. Description of Related Art

Conventionally, to print a file stored in a mobile electronic device using a printer, it is necessary to install a driver corresponding to the printer in the mobile electronic device, which is only useful for that printer, and the process must be repeated for use of other printers. All of which is time-consuming and inconvenient. Therefore, it is desirable for users to configure a wireless printing environment to print files from a mobile electronic device without having to install the driver corresponding to the printer in the mobile electronic device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of a peripheral device for configuring a wireless printing environment, in accordance with an embodiment.

FIG. 2 is a diagram of a wireless printing environment, in accordance with an embodiment.

FIG. 3 is a diagram of a wireless printing environment configuring module of FIG. 1.

FIG. 4 is a flow chart of a method for configuring a wireless printing environment by using the peripheral device of FIG. 1.

### DETAILED DESCRIPTION

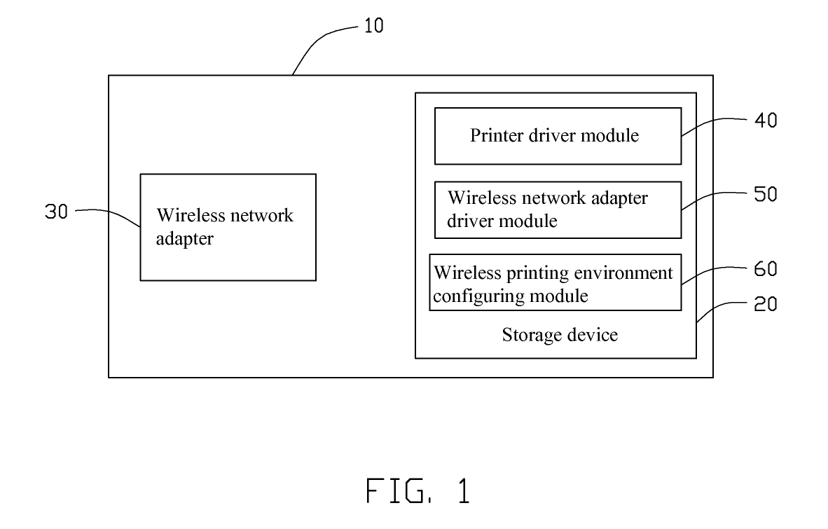

Referring to FIG. 1, an embodiment of a peripheral device 10 is capable of configuring a wireless printing environment for an electronic device such as a computer or personal digital assistant. The peripheral device 10 includes a storage device 20 and a wireless network adapter 30. The storage device 20 includes a printer driver module 40 storing a printer driver, a wireless network adapter driver module 50 storing a driver corresponding to the wireless network adapter 30, and a wireless printing environment configuring module 60. The peripheral device 10 can be shifted between a wireless connection mode and a storage mode.

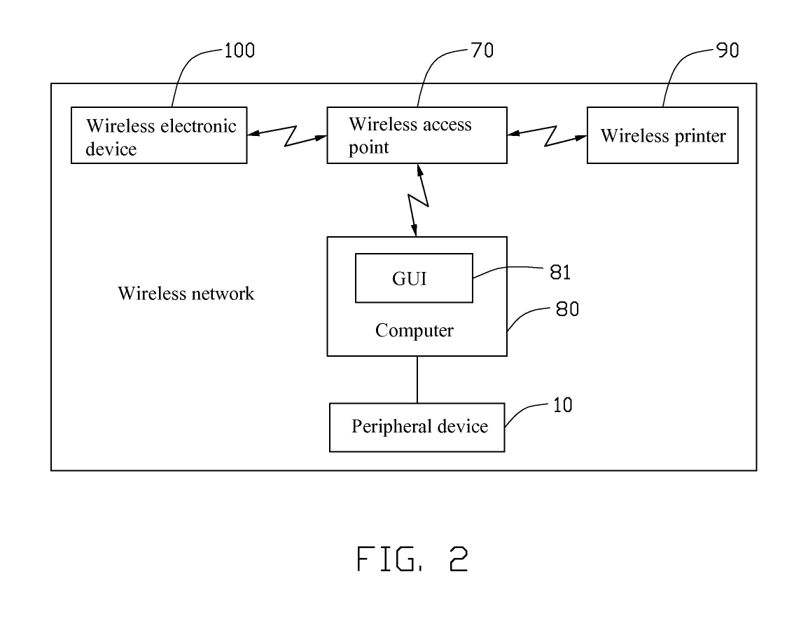

Referring to FIG. 2, the peripheral device 10 is coupled to a computer 80. A plurality of wireless universal plug and play printers 90, a plurality of wireless electronic devices 100, and the computer 80 are connected in a network. When the wireless network adapter 30 is configured in a right manner, the computer 80 will communicate with the wireless printers 90 and the wireless electronic devices 100 via wireless access points 70. In another embodiment, the wireless printers 90 can be replaced by general printers which are connected to the computer 80 via network (Internet or Local Area Network) wires. The computer 80 includes a graphic user interface 81, which is provided for users to access and configure the wireless network adapter 30. The wireless network adapter 30 enables the computer 80 to communicate with the printers 90 and the wireless electronic devices 100 upon 802.11b, WiFi, or other wireless communication protocols.

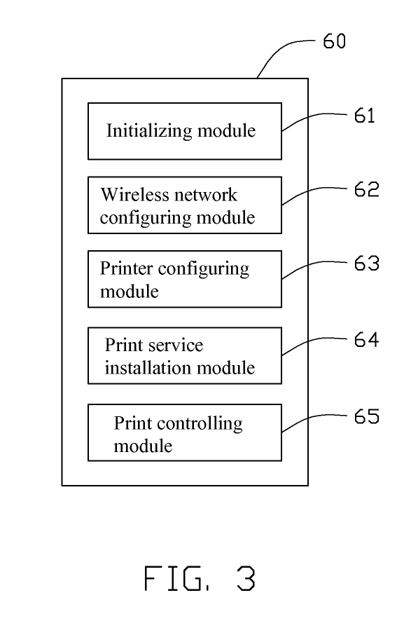

Referring to FIG. 3, the wireless printing environment configuring module 60 includes an initiating module 61, a wireless network configuring module 62, a printer configuring module 63, a print service installation module 64, and a print controlling module 65.

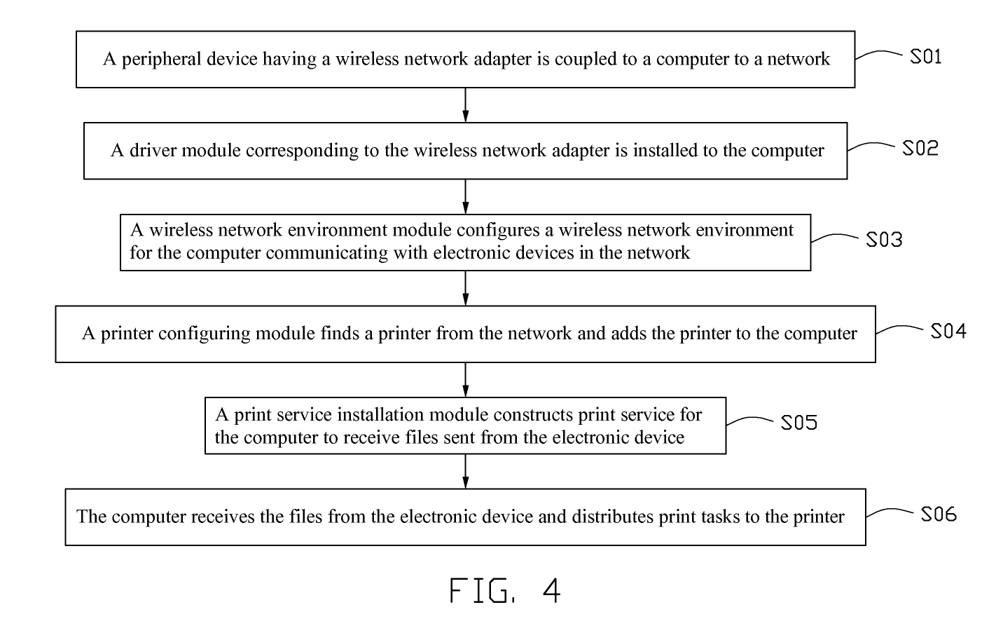

Referring to FIG. 4, an embodiment of a method for configuring a wireless printing environment for the computer 80 is shown.

In step 01, the computer 80, the wireless printer 90, and the electronic devices 100 are connected to a wireless network. The peripheral device 10 is coupled to the computer 80.

In step 02, when the peripheral device 10 is coupled to the computer 80, the initiating module 61 causes the computer 80 to execute initialization. The initiating module 61 installs the wireless network adapter driver to the computer 80, so that the peripheral device 10 can be identified when it is switched to a wireless connection mode. Meanwhile, the initiating module 61 copies wireless configuration files and installation files in the wireless network adapter driver module 50 to the computer 80.

In step 03, a user selects a wireless access point 70, and the wireless network configuring module 62 configures a wireless environment for the computer 80, so that the computer 80 can communicate with the printer 90 and the wireless electronic device 100 via the wireless access point 70.

In step 04, the printer configuring module 63 finds a printer 90 compatible with the printer driver from the network, and then installs the printer driver to the computer 80. Thus, the computer 80 is capable of communicating with the printer 90 and causing the printer 90 to print files. One of the methods for installing the printer driver is copying the printer driver to the computer 80 from the storage device 20, and then the printer configuring module 63 installs the printer driver in the computer 80. Another method would be to shift the peripheral device 10 to the storage mode, and then the printer configuring module 63 installs the printer driver in the computer 80.

In step 05, after the printer driver is installed in the computer 80, the print service installation module 64 constructs corresponding print service interfaces for different electronic devices 100, for example, Socket interface, Hypertext Transfer Protocol (HTTP) interface, and Simple Mail Transfer Protocol (STMP) interface, etc., so that the electronic devices 100 are capable of uploading files to the computer 80.

In step 06, the wireless printing environment configuration process for the computer 80 is finished. The computer 80 receives a file sent from the peripheral device 100 via the wireless network. Then, the printer control module 65 distributes a print task for the file to the printer 90 for printing. At this time, the computer 80 works as a print server system.

In the method for printing files as described above, if the user selects to print a file stored in the computer 80, the print process is the same as a conventional method for printing the file. If the user wants to print a file stored in some wireless peripheral device 100 which has a network browser, the peripheral device 100 opens the network browser and accesses the Internet Protocol (IP) address of the computer 80 to establish communication with the computer 80 and uploads files thereto via the HTTP interface. Then the print controlling module 65 causes the printer 90 to print the files. If the wireless peripheral device 100 is capable of sending emails, the computer 80 can receive a file from the wireless peripheral device 100 via the STMP interface. If the wireless peripheral device 100 does not have a network browser also cannot send emails, a Socket client program is installed in the wireless peripheral device 100. The peripheral device 100 can then send files to the computer Socket interface to print.

When the peripheral device 10 is coupled to the computer 80, the peripheral device 10 is capable of configuring a wireless printing environment for the computer 80. The computer 80 works as a print server system to open different interfaces corresponding to the different wireless electronic device 100, so as to provide print service for the wireless electronic device via the wireless network.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A device for configuring wireless printing environment, comprising:
a wireless network adapter;
a wireless network adapter driver; and
a wireless printing environment configuring module, capable of installing the wireless network adapter driver to a computer and configuring a wireless environment for the computer so as to enable the computer to communicate with wireless electronic devices via a wireless network, and the wireless printing environment module capable of finding a printer and providing print service for the computer.

2. The device of claim 1, wherein the peripheral device further comprises a printer driver module.

3. The device of claim 2, wherein the wireless printing environment configuring module further comprises a printer configuring module capable of finding the printer corresponding to the printer driver and building connection between the printer and the computer.

4. The device of claim 1, wherein the wireless printing environment configuring module further comprises an initializing module capable of installing the wireless network adapter driver in the computer.

5. The device of claim 4, wherein the wireless printing environment configuring module further comprises a wireless network configuring module capable of enabling the computer to communicate with the wireless electronic devices upon a wireless network protocol.

6. The device of claim 5, wherein the wireless printing environment configuring module further comprises print service providing module capable of constructing print service for the computer to receive files sent from the wireless electronic devices.

7. The device of claim 6, wherein the print service installation module capable of providing one of a socket interface, a HTTP interface, and a STMP interface to the computer.

8. The device of claim 6, wherein the wireless printing environment configuring module further comprises a print controlling module capable of causing the computer to distribute a print task to a printer.

9. A method for configuring a wireless printing environment for a computer by a peripheral device having a wireless network adapter, comprising:
connecting the computer to a network;
installing a driver corresponding to the wireless network adapter in the computer;
configuring a wireless network environment so that the computer communicates with electronic devices in the network according to a wireless network protocol;
finding a printer from the network and building connection between the printer and the computer; and
constructing print service for the computer to receive files sent from the electronic device.

10. The method of claim 9, wherein the electronic device stores a printer driver, and the step of finding the printer from the network and building connection between the printer and the computer comprises selecting a printer corresponding to the printer driver and installing the printer driver in the computer.

11. The method of claim 9, wherein the step of providing print service comprises installing one of a socket interface, a http interface, and a STMP interface to the computer.
